(19) United States
(12) Patent Application Publication
(10) Pub. No.: US 2026/0243402 A1
(43) Pub. Date: Aug. 20, 2026

(54) LIGHTING MODULE

(71) Applicant: VALEO VISION, Bobigny (FR)

(72) Inventors: Alexandre CORMAN, Bobigny (FR); Yves GROMFELD, Bobigny (FR)

(73) Assignee: VALEO VISION, Bobigny (FR)

(21) Appl. No.: 19/161,601

(22) PCT Filed: Feb. 13, 2024
(86) PCT No.: PCT/EP2024/053555

§ 371 Date: Sep. 2, 2025

(30) Foreign Application Priority Data
Mar. 1, 2023 (FR) FR2301904

(51) Int. Cl. F21S 41/265; F21S 41/143; F21S 41/151; F21S 41/24; F21S 43/14; F21S 43/20; F21S 43/236; F21W 102/145

(52) U.S. Cl. CPC F21S 41/265; F21S 41/143; F21S 41/151; F21S 41/24; F21S 43/14; F21S 43/236; F21S 43/26231; F21W 2102/145

(57) ABSTRACT

The invention relates to a lighting module including an upper row of light sources, an upper row of upper light guides, each of which is associated with an upper light source, a lower row of lower light sources, a lower row of lower light guides, each of which is associated with a lower light source, and a primary lens that has an optical axis and includes an exit dioptric interface. The exit dioptric interface includes an upper portion with a lower edge and a lower portion with an upper edge. The lower edge and the upper edge are connected by a connecting section. The upper edge is further forward with respect to the primary lens than the lower edge in the direction of the optical axis.

### TECHNICAL FIELD

The present invention relates to the field of lighting, this including signaling, and to the field of the units, in particular optical units, that contribute thereto. It is particularly advantageously applicable to the field of automotive vehicles. In particular, it relates to a lighting module.

### BACKGROUND OF THE INVENTION

In the automotive sector, modules capable of emitting light beams, also referred to as lighting and/or signaling functions, are known.

These modules have to meet the applicable regulations, in particular to allow sufficient safety and comfort, by emitting light specifically in certain zones such that zones that should remain dark are excluded, and uniformly so that there are no dark zones left in the zone that should be lit. One of the constraints that manufacturers also face is the reduction of the size of the module, in order to obtain a module that is the most easily usable.

In order to as best as possible achieve these various objectives and in particular obtain a device emitting a beam that comfortably lights up the road, a technical solution implementing a device with a particular configuration of the exit dioptric interface of the primary lens has been proposed in document EP3301347 A1.

However, this type of technical solution has drawbacks, notably the fact that it is limited in terms of safety and comfort.

An object of the present invention is therefore to provide a lighting module that makes it possible to overcome all or some of the cited drawbacks.

The other objects, features and advantages of the present invention will become apparent upon studying the following description and the accompanying drawings. It will be understood that other advantages may be incorporated.

### SUMMARY OF THE INVENTION

To achieve this objective, according to one embodiment, a lighting module is provided, which comprises:
an upper row of upper light sources, light rays originating from the upper row being intended to generate a first beam, the upper light sources being aligned in a direction,
an upper row of upper light guides each comprising an upper entry face and an upper exit face, the upper light guides each being separately associated with an upper light source, each upper light guide conducting light rays originating from the associated upper light source from the upper entry face to the upper exit face of the upper light guide,
a lower row of lower light sources, light rays originating from the lower row being intended to generate a second beam, the lower light sources being aligned in the direction,
a lower row of lower light guides each comprising a lower entry face and a lower exit face, the lower light guides each being separately associated with a lower light source, each lower light guide conducting light rays originating from the associated lower light source from the lower entry face to the lower exit face of the lower light guide,
a primary lens having an optical axis and configured to receive the light rays originating from the upper light sources and lower light sources, the primary lens comprising an exit dioptric interface,
a first plane comprising the optical axis and being parallel to the direction and
second planes (p2) perpendicular to the direction (d),
wherein one from among the first beam and the second beam is a complementary high beam and
characterized in that the exit dioptric interface comprises a convex upper part comprising a lower edge and a convex lower part comprising an upper edge, the upper part being at least predominantly intended for the exit of the light rays originating from the upper row, the lower part being at least predominantly intended for the exit of the light rays originating from the lower row, the lower edge and the upper edge being joined by a connecting portion, the upper edge being farther in front of the primary lens than the lower edge is, in the direction of the optical axis.

As a result, the connecting portion makes it possible to obtain a uniform resultant lighting, i.e. lighting which does not have dark zones, typically directed in a horizontal direction, included in the zone that needs to be lit (these horizontal dark zones being caused by the join between the different rows of light sources). Specifically, owing to its configuration, the connecting zone associated with a portion of the lower part (it being possible for this portion of the lower part to have a height between the height of the connecting portion and three times the height of the connecting portion) creates, on the primary exit dioptric interface, a local zone of vertical deflection of the light rays that have traversed it. This deflection creates, as can be seen in FIG. 5B in comparison with FIG. 5A (which shows the lighting resulting from a primary exit dioptric interface that does not have a connecting portion), a more uniform light distribution which also has a greater downward extent. This configuration of the exit dioptric interface of the primary lens and in particular the resultant uniform lighting thus makes it possible to achieve increased safety and comfort. Given that the connecting portion is located between the upper part and the lower part, that the upper part is at least predominantly intended for the exit of the light rays originating from the upper row, and that the lower part is at least predominantly intended for the exit of the light rays originating from the lower row, the connecting portion constitutes either an exit for a greater proportion of light rays coming from the upper row (in relation to the lower row), or an exit for a greater proportion of light rays coming from the lower row (in relation to the upper row), or an exit for an equal proportion of rays originating from the upper row and rays originating from the lower row. Thus, depending on the position of the connecting portion in relation to the light guides, the uniform lighting owing to the passage of some light rays through the connecting portion will either be for a greater proportion for the first beam (in relation to the second beam), or for a greater proportion for the second beam (in relation to the first beam), or for an equal proportion for the first beam and for the second beam. It will therefore be possible to configure the connecting portion so that the uniform effect of the lighting is obtained at the desired area of the road. In particular, if regulations mean that it is necessary for the light rays of a beam in particular not to have traversed the connecting portion, it will be possible to position the connecting portion accordingly.

The invention also sets out a vehicle equipped with at least one such module, and preferably at least one pair of such modules, each of the modules of the pair equipping one side of the vehicle front end.

### BRIEF DESCRIPTION OF THE DRAWINGS

The aims, objects, features and advantages of the invention will become more clearly apparent from the detailed description of one embodiment thereof, which is illustrated by the following accompanying drawings, in which:

FIG. 1 shows a bottom view of the lighting module according to the invention.

FIG. 2 shows a sectional view on the plane (y0z) of the lighting module according to one embodiment of the invention.

FIG. 3 shows the detail A of the exit dioptric interface of the primary lens in FIG. 2 so that the configuration of the connecting portion according to one embodiment of the invention is schematically shown.

FIG. 4 shows the lighting module in FIG. 1, on which the intermediate lens and the projection lens are shown.

FIG. 5A shows the isocandela curves of the luminous intensity originating from a beam obtained with a lighting module having a primary exit dioptric interface which does not have a connecting portion.

FIG. 5B shows the isocandela curves of the luminous intensity originating from a beam obtained with a lighting module having a primary exit dioptric interface which has a connecting portion according to the invention.

The drawings are provided by way of example and do not limit the invention. They are schematic conceptual representations intended to facilitate understanding of the invention and are not necessarily drawn to the scale of practical applications.

### DETAILED DESCRIPTION OF THE INVENTION

Before starting a detailed review of embodiments of the invention, optional features that may optionally be used in combination or alternatively will be described below:

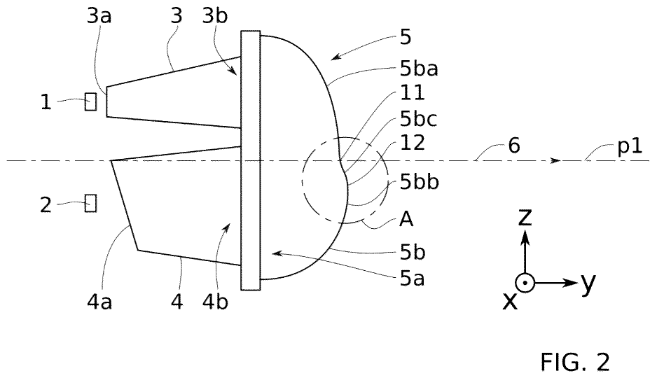

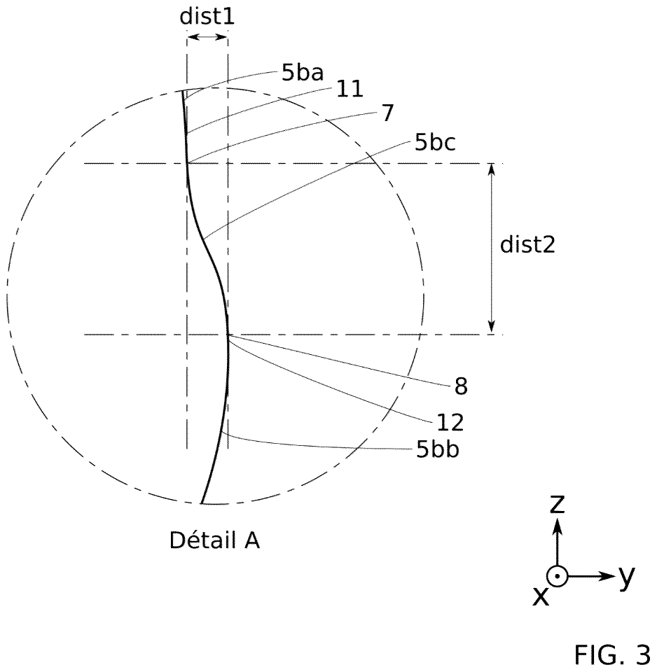

According to one example, in FIG. 2 and FIG. 3, the upper part 5ba and the lower part 5bb are configured such that, in all the second planes p2, the upper edge 12 is farther in front of the primary lens 5 than the lower edge 11 is, in the direction of the optical axis 6, by a first distance dist1 of between 0.07 mm and 0.2 mm, the first distance dist1 having the same value in all the second planes p2, and preferably the first distance dist1 is equal to 0.12 mm.

The first distance dist1 has been selected so as to obtain the necessary spacing in the horizontal direction between the lower edge 11 and the upper edge 12 to achieve the desired deflection of the rays traversing in particular the connecting portion 5bc and thus the desired resultant uniformity.

According to one example, in all the second planes p2, the lower edge 11 is positioned above the upper edge 12, by a second distance dist2 of between 0.2 mm and 1.3 mm.

In the same way as for the first distance dist1, the second distance dist2 is determined so that the drop between the lower edge 11 and the upper edge 12 makes it possible to achieve a resultant lighting that has the desired properties.

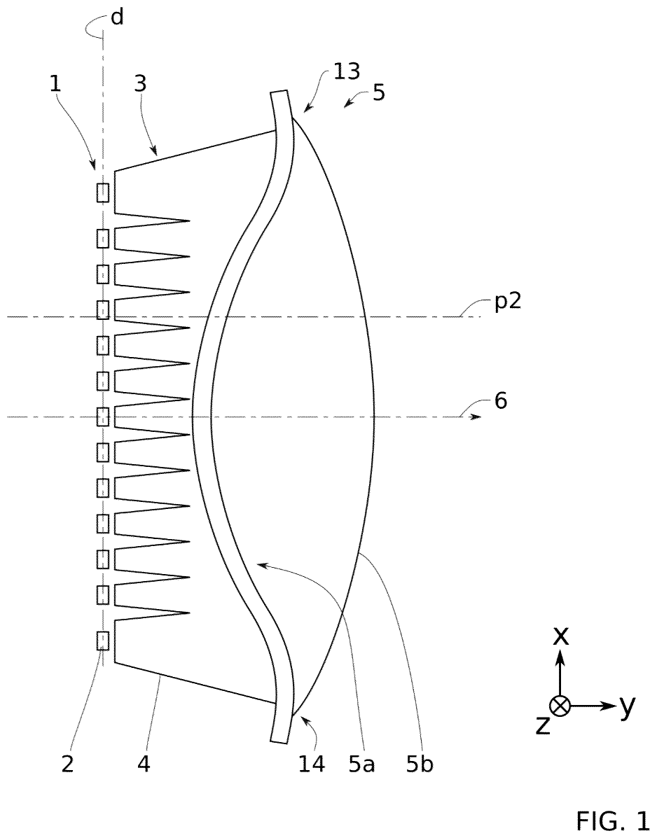

According to one example, in FIG. 1 and FIG. 3, the second distance dist2 at the two lateral ends 13, 14 is strictly less than the second distance dist2 on the optical axis 6.

According to one example, the second distance dist2 at the two lateral ends 13, 14 is comprised between 0.2 mm and 0.4 mm, the second distance dist2 decreasing between the optical axis 6 and the lateral ends 13, 14.

These two configurations make it possible to create more deflection and thus a greater blurring effect on the optical axis 6 than at the two ends 13, 14.

According to one example, the join between the lower edge 11 and the connecting portion 5bc is located in a plane parallel to the first plane p1 and extending at an equal distance from the upper exit face 3b and from the lower exit face 4b.

As a result, owing to this configuration, the connecting portion will be located such that it will be intercepted by a greater proportion of light rays originating from the lower row than light rays originating from the upper row. More specifically, owing to its position in this configuration, at least 80% of the connecting portion will be intercepted by light rays originating from the lower row and at most 20% of the connecting portion will be intercepted by light rays originating from the upper row. In addition, given the position of the connecting portion, the uniform lighting will be located virtually completely at the second beam and partially at the first beam for that part of the first beam that is close to the second beam.

According to one example, the connecting portion 5bc comprises an upper zone 7 and a lower zone 8, the upper zone 7 being positioned in contact with the upper part 5ba, the lower zone 8 being positioned in contact with the lower part 5bb, the upper zone 7 and the lower zone 8 being configured such that they each describe a curvature, in such a way that, at each point of the join between the upper zone 7 and the lower edge 11, the tangents of the upper zone 7 and the lower edge 11 are identical and, at each point of the join between the lower zone 8 and the upper edge 12, the tangents of the lower zone 8 and the upper edge 12 are identical.

Thus, this configuration and in particular the curved shape of the upper zone 7 and of the lower zone 8 makes it possible to obtain a smooth exit dioptric interface 5b which does not have projecting parts that can cause undesired effects, in particular divergent orientations of the light rays.

According to one example, the connecting portion 5bc is concave, the upper zone 7 and the lower zone 8 each exhibiting a change of inflection.

For instance, for the configuration of a concave connecting portion 5bc, the presence of this point of inflection makes it possible to ensure the absence of projecting parts at the join between the connecting portion 5bc and the rest of the dioptric interface.

According to one example, the connecting portion 5bc is convex, the upper zone 7 exhibiting a change of inflection.

For instance, like for the configuration of the concave connecting portion 5bc, the configuration of the convex connecting portion 5bc makes it possible to obtain a smooth surface at the join between the connecting portion 5bc and the rest of the dioptric interface.

According to one example, the primary lens 5 comprises an entrance dioptric interface 5a, the entrance dioptric interface 5a being in contact with the upper exit face 3b of the upper light guides 3 and the lower exit face 4b of the lower light guides 4.

As a result, by virtue of this configuration, the light rays at the exit of the light guides directly intercept the primary lens and thus do not lose the direction given to them by the light guide.

According to one example, the upper part 5ba has, in a plane parallel to the first plane p1 and passing through the lower edge 11, a radius of curvature greater than or equal to 100 mm.

Thus, the selection of a radius of curvature greater than or equal to 100 mm for the upper part makes it possible to reduce, generally speaking, the length taken up by the lighting module (at the upper part) and, in some cases, the overall volume taken up by the lighting module, this having the consequence of increasing the resulting compactness of the lighting module. Furthermore, the selection of this low curvature makes it possible to keep light concentrated in the zone comprising the lower edge, the upper edge and the connecting portion.

According to one example, the lower part 5bb has, in a plane parallel to the first plane pl and passing through the upper edge 12, a radius of curvature greater than or equal to 100 mm.

Thus, in the same way as for the upper part, the radius of curvature at the lower part has been selected such that a compactness of the lighting module is obtained and also such that light is kept concentrated in the zone comprising the upper edge, the lower edge and the connecting portion.

According to one example, the first beam is a cut-off beam of a low-beam and the second beam is a complementary high beam.

For instance, if the join between the lower edge 11 and the connecting portion 5bc is located in a plane parallel to the first plane pl and extending at an equal distance from the upper exit face 3b and the lower exit face 4b, which is associated with the case where the first beam is a cut-off beam of a low-beam and the second beam is a complementary high beam and with the case where the connecting portion is traversed solely by rays originating from the lower row (i.e. with the case where that part of the dioptric interface that is underneath the lower edge is traversed solely by rays originating from the lower row), the effect of the connecting portion will be to blur solely the rays forming the complementary high beam and not the cut-off beam of a low-beam (which would create a problem in terms of regulations).

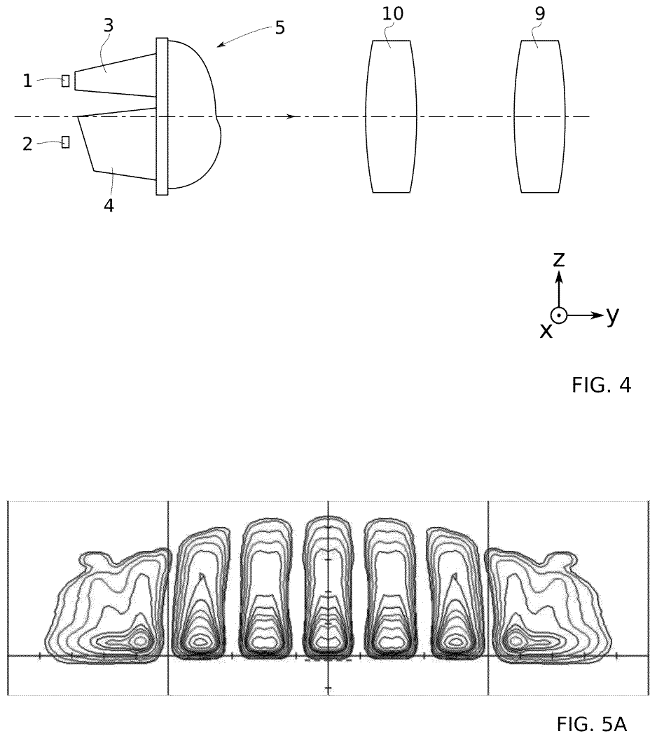

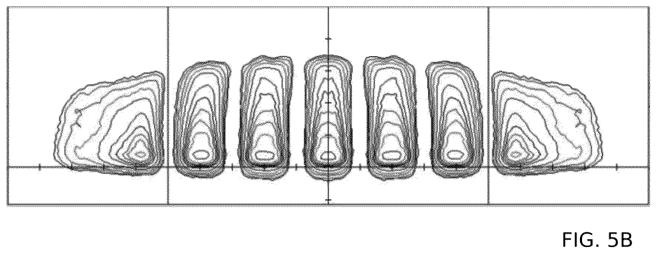

According to one example, in FIG. 4, the lighting module comprises an intermediate lens 10 and a projection lens 9, the intermediate lens 10 being positioned along the optical axis 6 of the primary lens 5 after the primary lens 5, the projection lens 9 being positioned along the optical axis 6 of the primary lens 5 after the intermediate lens 10.

Combining a primary lens with a projection lens makes it possible to obtain the desired distribution of light in a plane perpendicular to the optical axis while still having sufficient luminous power and imaging quality. The aim of the positioning of an intermediate lens between the primary lens and the projection lens is to make it possible to reduce or limit geometric aberrations.

With respect to the features set out here, terms relating to verticality, horizontality or transversality (or even the lateral position or direction), or equivalents thereof, are to be understood with respect to the position in which the lighting system is intended to be mounted in a vehicle. The terms “vertical” and “horizontal” are used in the present description to denote, regarding the term “vertical”, a direction with an orientation perpendicular to the plane of the horizon (which corresponds to the height of the systems), and, regarding the term “horizontal”, a direction with an orientation parallel to the plane of the horizon. They are to be considered under the conditions of operation of the module in a vehicle. The use of these words does not mean that slight variations about the vertical and horizontal directions are excluded from the invention. For example, an inclination relative to these directions of the order of + or −10° is here considered to be a minor variation about the two preferred directions. With respect to the horizontal plane, the inclination is in principle comprised between −5° and +4°, and is comprised between −6° and +7.5° laterally.

In the context of the present description, the adjectives “lower” and “upper”, and equivalents thereof (under, below, over, above), are to be considered in relation to the vertical direction, that is to say the direction perpendicular to the direction d and to the optical axis 6. In the same context, an upper element is situated above (but not necessarily in contact or directly in line with) a lower element, in the vertical direction. Thus, in the context of the present invention, the lower part is positioned above the lower part. In the same way, the upper row of upper light sources, the upper row of upper light guides, the upper entry face, the upper exit face and the upper zone are situated above the lower row of lower light sources, the lower row of lower light guides, the lower entry face, the lower exit face and the lower zone, respectively.

It is specified that, in the context of the present invention, “at least predominantly” means that at least 50% of the element in question is taken into consideration.

The “lower edge” and “upper edge” are understood to be the lower perimeter of the upper part and the upper perimeter of the lower part, respectively. The “lower edge” and the “upper edge” delimit the upper part of the connecting portion and the lower part of the connecting portion, respectively.

The expression “farther in front”, in the context “the upper edge being farther in front of the primary lens than the lower edge is, in the direction of the optical axis” means that the upper edge is farther away from the rows of sources than the lower edge is. Thus, the front is situated away from the back with respect to the position of the rows of light sources. In a different way, the front is to be taken into account considering the direction of the light rays and more specifically that the light rays are directed from the back to the front.

In the context of the present invention, the expressions “identical tangents” and “equal tangents” mean that, in a two-dimensional coordinate system, the mathematical equations of the identical (or equal) tangents are the same.

According to a preferred embodiment, the lighting module comprises an upper row of upper light sources 1, an upper row of upper light guides 3, a lower row of lower light sources 2, a lower row of lower light guides 4 and a primary lens 5.

Light rays originating from the upper row 1 are intended to form a first beam. The upper light sources 1 are arranged in a row on a straight line in a direction d. The upper light guides 3 each comprise an upper entry face 3a and an upper exit face 3b. The upper light guides 3 are each separately associated with an upper light source 1. As a result, each upper light guide 3 forms a pair with an upper light source 1. Each upper light guide 3 consists of a conductor for transmitting the light originating from the associated upper light source 1 from the upper entry face 3a to the upper exit face 3b of the upper light guide 3.

Light rays originating from the lower row 2 are intended to form a second beam. The lower light sources 2 are arranged in a row on a straight line in the direction d. The lower light guides 4 each comprise a lower entry face 4a and a lower exit face 4b. The lower light guides 4 are each separately associated with a lower light source 2. As a result, each lower light guide 4 forms a pair with a lower light source 2. Each lower light guide 4 consists of a conductor for transmitting the light originating from the associated lower light source 2 from the lower entry face 4a to the lower exit face 4b of the lower light guide 4.

The primary lens 5 has an optical axis 6. The primary lens 5 is configured such that the light rays originating from the first row of sources and from the second row of sources are refracted there. The primary lens 5 comprises an exit dioptric interface 5b, a first plane p1 comprising the optical axis 6 and being parallel to the direction d and second planes p2 perpendicular to the direction d. One from among the first beam and the second beam is a complementary high beam.

The exit dioptric interface 5b comprises an outwardly rounded upper part 5ba and a likewise outwardly rounded lower part 5bb. The upper part 5ba comprises a lower edge 11. The lower part 5bb comprises an upper edge 12. The upper part 5ba is at least partly intended for the exit of the light rays originating from the upper row 1. At least 50% of the light rays originating from the upper row 1 are refracted on the upper part 5 ba. With preference, 70%, if not 90%, if not 99%, if not 100% of the light rays originating from the upper row 1 are refracted on the upper part 5ba. The lower part 5bb is at least partly intended for the exit of the light rays originating from the lower row 2. At least 50% of the light rays originating from the lower row 2 are refracted on the lower part 5bb. With preference, 70%, if not 90%, if not 99%, if not 100% of the light rays originating from the lower row 4 are refracted on the lower part 5bb. The connecting portion 5bc is positioned between the lower edge 11 and the upper edge 12 such that the lower edge 11 stays integral with the upper edge 12. The upper edge 12 is downstream of the primary lens 5 in relation to the lower edge 11 in the direction of the optical axis 6.

There may be 12 light sources in the upper row 1. There may be 12 light sources in the lower row 2. There may also be 1, 2, 3, 4, 5, 6, 8 or 10 light sources in the upper row 1. There may be 1, 2, 3, 4, 5, 6, 8 or 10 light sources in the lower row 2.

With preference, the upper part 5ba and the lower part 5bb are configured such that, in all the second planes p2, i.e. in all the vertical planes (or planes perpendicular to the first plane p1), the upper edge 12 is farther downstream of the primary lens 5 than the lower edge 11 is, in the direction of the optical axis 6, by a first distance dist1 of between 0.07 mm and 0.2 mm. The first distance dist1 is constant along the lower edge and also along the upper edge. The first distance dist1 is measured in a direction parallel to the first plane p1 and typically in the direction of the optical axis. This distance allows the upper edge to be in front of the lower edge, i.e. farther downstream in the direction of propagation of the light, or else farther away from the rows of sources. The first distance dist1 is preferably equal to 0.12 mm.

With preference, in all the second planes p2, i.e. in all the vertical planes (or planes perpendicular to the first plane p1), the lower edge 11 is positioned higher up than the upper edge 12 by a second distance dist2 of between 0.2 mm and 1.3 mm. The second distance dist2 is measured in a direction perpendicular to the first plane p1. Typically, this direction is a height dimension of the module, preferably a vertical dimension.

According to an advantageous embodiment, the second distance dist2 at the two lateral ends 13, 14, i.e. at the two positions of the upper edge and lower edge that are farthest away from the optical axis (these two positions being opposite with respect to the optical axis), is strictly less than the second distance dist2 on the optical axis 6. The second distance dist2 at the two lateral ends 13, 14 is comprised between 0.2 mm and 0.4 mm. The second distance dist2 decreases between the optical axis 6 (where it may have a value of 1 mm) and the lateral ends 13, 14 (where it may have a value of 0.3 mm).

Advantageously, the connection between the lower edge 11 and the connecting portion 5bc is located in a plane parallel to the first plane pl and extending at an equal distance from the upper exit face 3b and from the lower exit face 4b.

The join between the lower edge 11 and the connecting portion 5bc is preferably included in the first plane p1.

According to a preferred example, the connecting portion 5bc comprises an upper zone 7 and a lower zone 8. The upper zone 7 is positioned such that it is next to the upper part 5ba. The lower zone 8 is positioned such that it is next to the lower part 5bb. The upper zone 7 and the lower zone 8 describe a curve.

The upper zone 7 is configured such that, at each point of the connection between the upper zone 7 and the lower edge 11, the tangents of the upper zone 7 and the lower edge 11 are equal (in order that, at the join between the upper zone 7 and the lower edge 11, the resulting curvature has a smooth zone and thus does not have a projecting angular part). The lower zone 8 is configured such that, at each point of the join between the lower zone 8 and the upper edge 12, the tangents of the lower zone 8 and the upper edge 12 are equal (in order that, at the join between the lower zone 8 and the upper edge 12, the resulting curvature has a smooth zone and thus does not have a projecting angular part).

The connecting portion 5bc is preferably inwardly rounded. The upper zone 7 and the lower zone 8 each exhibit a change in convexity.

According to an advantageous example, the connecting portion 5bc is outwardly rounded. The upper zone 7 exhibits a change in convexity.

The primary lens 5 preferably comprises an entrance dioptric interface 5a. The entrance dioptric interface 5a is connected to the upper exit face 3b of the upper light guides 3 and to the lower exit face 4b of the lower light guides 4.

Advantageously, the upper part 5ba has, in a plane parallel to the first plane p1 and passing through the lower edge 11, a radius of curvature greater than or equal to 100 mm.

Advantageously, the lower part 5bb has, in a plane parallel to the first plane p1 and passing through the upper edge 12, a radius of curvature greater than or equal to 100 mm.

In the two zones of the primary lens that are mutually symmetrical with respect to the optical axis (i.e. an upper end and a lower end of the primary lens), the curvature of the primary lens is greater (than the curvature of the lens on the optical axis) such that a good coupling of light is maintained.

With preference, the entrance dioptric interface 5a also has, in the first plane p1, a radius of curvature greater than or equal to 100 mm such that the compactness of the lighting module is increased.

Advantageously, the first beam is a cut-off beam of a low-beam and the second beam is a complementary high beam.

The module may also be used for other lighting functions (in particular a low-beam near-field beam) via or apart from those described above, in relation to adaptive beams. It is thus possible to produce a lighting matrix with a view to selectively illuminating portions of the space in front of the vehicle.

The low-beam near-field beam can also be referred to as a “flat” or spread beam. A flat beam is projected widely under the cutoff and serves to illuminate the near field in front of the vehicle.

The cut-off beam for low-beam allows a cut-off zone to be defined. Thus, the combination of the near-field beams and the cut-off beam for low-beam makes it possible to at least partially define a low beam.

The cut-off beam for low-beam is therefore configured to produce, in low-beam mode, a cut-off segment of a low beam. The resulting angled portion is referred to as the kink of the “low” or “dipped” beam. Beams of the low-beam type typically have a first lateral zone (normally at the edge of the roadway) that projects at a slightly greater height than in a second lateral zone (normally at the center of the roadway), these two zones following one another laterally with the presence of a bend or kink between them.

A near-field beam of a low beam is typically a projection that is relatively spread out laterally in front of the vehicle, predominantly or completely below the horizon line, a good distribution of the illumination over the entire zone that is lit generally being sought.

The invention may contribute to a high-beam function which has the purpose of illuminating the scene in front of the vehicle over a wide area, but also over a substantial distance, typically about two hundred meters. This light beam, because of its lighting function, is mainly located above the horizon line. It may for example have a slightly upward sloping lighting optical axis. In particular, it may be used to generate a “complementary” lighting function that forms a portion of a high beam complementary to a portion produced by a near-field beam, the aim of this complementary high beam being solely, or at least mainly, to light above the horizon line, whereas the aim of the near-field beam (which may have the specific features of a low beam) is solely, or at least mainly, to light below the horizon line. The complementary high beam may therefore be a main part of the overall “high” or “main” beam and be associated with another beam contributing to the low or dipped beam.

According to a preferred exemplary embodiment, the optical axis 6 and the direction d are orthogonal.

The lighting module preferably comprises an intermediate lens 10 and a projection lens 9. The intermediate lens 10 and the projection lens 9 are positioned along the optical axis such that the light rays originating from the rows of light sources intercept the primary lens first, the intermediate lens second and the projection lens third.

The projection lens may be made of polymethylmethacrylate. The intermediate lens may be made of polycarbonate. The primary lens is preferably made of silicone.

The entrance dioptric interface of the primary lens is separated from the exit dioptric interface of the projection lens by a distance of between 70 mm and 90 mm. The exit dioptric interface of the primary lens is separated from the entrance dioptric interface of the projection lens by a distance of between 50 mm and 60 mm. These distances are measured on the optical axis 5.

The intermediate lens and the projection lens may have a focal length of between 55 and 60 mm, and this focal length can preferably be 58 mm (this distance being an imaginary length calculated from the overall image/object magnification of the system composed of the intermediate lens and the projection lens). The field of view of the beam originating from the rows of the projection lens may be 35°.

Advantageously, the primary lens and the intermediate lens have a size of 30 by 60 mm (taking into account the fastening zones). If the invention provides several lighting modules and they are separate, the projection lens may have a width of 45 mm and a height of between 30 mm and 40 mm (i.e. in the vertical direction). If the invention provides several lighting modules and they are linked, the overall projection lens of the system (i.e. the overall projection lens consisting of the combination of multiple individual projection lenses) may have a height of 30 mm and a width of between 100 and 120 mm.

The upper light sources 1 can preferably be switched on selectively and individually. With preference, the lower light sources 4 can be switched on selectively and individually.

Thus, by virtue of this configuration, the LEDs of the lighting module may be selectively switched on or off in order to give the resulting lighting the desired configuration. This configuration therefore makes it possible to control the luminosity in the zone in question. The abbreviation ADB (for adaptive driving beam) is used for this type of function.

Specifically, selective activation of the light sources makes it possible to obtain varied light beam configurations making it possible to adapt to various situations. The zones that should be lit thus are, and those in which the brightness should be reduced due to regulatory constraints also will be.

This discretization of the light is also referred to as a segmented beam. A beam of which the projection forms an image composed of beam segments, each segment being able to be switched on independently, is thus referred to as a segmented beam.

Thus, all the emissive elements are not necessarily active, i.e. emit light, simultaneously. This function allows the shape of the generated beam to be modulated. If a light source is not activated, its image, as projected by the optical module, will be null. It then forms a lighting void in the resulting overall beam. This void is interrupted only by source-coupling effects and the effects of stray light from the optics.

The system according to the invention may comprise a unit for driving the activation of each of the sources that is configured to produce at least one dark zone forming a tunnel in a projected beam by deactivating a group of adjacent sources, the driving unit being configured to determine the number of sources of the group corresponding to the dark zone depending on the widthwise dimension of the sources.

The driving unit may comprise a computer program product, preferably stored in a non-transitory memory, the computer program product comprising instructions that, when executed by a processor, determine the sources to be activated, in particular to obtain at least one dark zone (in which the sources are not activated) of defined area, taking into account the variable surface area of the images of the elements.

The centers of two adjacent light sources (in one and the same row) may be at a distance of 3 mm. The center of a light source of the row of upper sources and the center of a light source of the row of lower sources may be separated by a distance of between 2 mm and 4 mm.

The light sources of the overall device may be light-emitting diodes, also commonly called LEDs.

Advantageously, the LEDs of the overall lighting module have an emissive surface area of 0.5 mm² or of 1 mm² . The size of the LEDs is directly related to the size of the pixels of light obtained and also related to the desired beam volume. Moreover, in order to obtain a large beam volume, it is also possible to add rows of LEDs.

The invention is not limited to the embodiments described above and encompasses any embodiment covered by the invention.

### LIST OF REFERENCES

1. upper row of upper light sources
2. lower row of lower light sources
3. upper row of upper light guides
3a. upper entry face
3b. upper exit face
4. lower row of lower light guides
4a. lower entry face
4b. lower exit face
5. primary lens
5a. entrance dioptric interface
5b. exit dioptric interface
5ba. upper part
5bb. lower part
5bc. connecting portion
6. optical axis
7. upper zone
8. lower zone
9. projection lens
10. intermediate lens
11. lower edge
12. upper edge
13, 14. two lateral ends
d. direction
p1. first plane
p2. second planes
dist1. first distance
dist2. second distance

What is claimed is:

1. A lighting module comprising:
an upper row of upper light sources, light rays originating from the upper row being intended to generate a first beam, the upper light sources being aligned in a direction,
an upper row of upper light guides each including an upper entry face and an upper exit face, the upper light guides each being separately associated with an upper light source, each upper light guide conducting light rays originating from the associated upper light source from the upper entry face to the upper exit face of the upper light guide,
a lower row of lower light sources, light rays originating from the lower row being intended to generate a second beam, the lower light sources being aligned in the direction,
a lower row of lower light guides each including a lower entry face and a lower exit face the lower light guides each being separately associated with a lower light source, each lower light guide conducting light rays originating from the associated lower light source from the lower entry face to the lower exit face of the lower light guide,
a primary lens having an optical axis and configured to receive the light rays originating from the upper light sources and lower light sources, the primary lens comprising an exit dioptric interface,
a first plane including the optical axis and being parallel to the direction and
second planes perpendicular to the direction,
wherein one from among the first beam and the second beam is a part high complementary high beam and
the exit dioptric interface includes a convex upper part including a lower edge and a convex lower part comprising-including an upper the upper part being at least predominantly intended for the exit of the light rays originating from the upper row, the lower part being at least predominantly intended for the exit of the light rays originating from the lower row, the lower edge and the upper edge being joined by a connecting portion the upper edge being farther in front of the primary lens, in the direction of the optical axis, than the lower edge is, in the direction of the optical axis.

2. The lighting module as claimed in claim 1, wherein the upper part and the lower part are configured such that, in all the second planes, the upper edge is farther in front of the primary lens, in the direction of the optical axis, than the lower edge is, in the direction of the optical axis, by a first distance of between 0.07 mm and 0.2 mm, the first distance having the same value in all the second planes.

3. The lighting module as claimed in claim 1, wherein, in all the second planes, the lower edge is positioned above the upper edge, by a second distance of between 0.2 mm and 1.3 mm.

4. The lighting module as claimed in claim 3, wherein the second distance at two lateral ends of the primary lens is strictly less than the second distance on the optical axis.

5. The lighting module as claimed in claim 4, wherein the second distance at the two lateral ends is between 0.2 mm and 0.4 mm, the second distance decreasing between the optical axis and the lateral ends.

6. The lighting module as claimed in claim 1, wherein a join between the lower edge and the connecting portion is located in a plane parallel to the first plane and extending at an equal distance from the upper exit face and from the lower exit face.

7. The lighting module as claimed in claim 1, wherein the connecting portion includes an upper zone and a lower zone, the upper zone being positioned in contact with the upper part, the lower zone being positioned in contact with the lower part the upper zone zone and the lower zone being configured such that they each describe a curvature, in such a way that, at each point of the a join between the upper zone and the lower edge the tangents of the upper zone and the lower edge are identical and, at each point of the a join between the lower zone and the upper edge the tangents of the lower zone and the upper edge are identical.

8. The lighting module as claimed in claim 7, wherein the connecting portion is concave, the upper zone and the lower zone each exhibiting a change of inflection.

9. The lighting module as claimed in claim 7, wherein the connecting portion is convex, the upper zone exhibiting a change of inflection.

10. The lighting module as claimed in claim 1, wherein the primary lens includes an entrance dioptric interface, the entrance dioptric interface being in contact with the upper exit face of the upper light guides and the lower exit face of the lower light guides.

11. The lighting module as claimed in claim 1, wherein the upper part has, in a plane parallel to the first plane and passing through the lower edge, a radius of curvature greater than or equal to 100 mm.

12. The lighting module as claimed in claim 1, wherein the lower part has, in a plane parallel to the first plane and passing through the upper edge, a radius of curvature greater than or equal to 100 mm.

13. The lighting module as claimed in claim 6, wherein the first beam is a cut-off beam of a low-beam and wherein the second beam is a complementary high beam.

14. The lighting module as claimed in claim 1, further comprising an intermediate lens and a projection lens, the intermediate lens being positioned along the optical axis of the primary lens after the primary lens, the projection lens being positioned along the optical axis of the primary lens after the intermediate lens
